(19) United States
(12) Patent Application Publication
(10) Pub. No.: US 2026/0245749 A1
(43) Pub. Date: Aug. 20, 2026

(54) INERTIAL FUSION ENERGY GENERATION SYSTEMS AND METHODS

(71) Applicant: Michael Edwin Glinsky, Santa Fe, NM (US)

(72) Inventor: Michael Edwin Glinsky, Santa Fe, NM (US)

(21) Appl. No.: 19/544,373

(22) Filed: Feb. 19, 2026

Related U.S. Application Data
(60) Provisional application No. 63/760,917, filed on Feb. 20, 2025.

(51) Int. Cl. G21B 1/23; G21B 1/03

(52) U.S. Cl. CPC G21B 1/23; G21B 1/03

(57) ABSTRACT

Inertial fusion energy generation techniques that involve an inertial fusion target including an inner fuel disposed in an interior region of the target, an outer fuel surrounding the inner fuel, and a pusher material surrounding the outer fuel, and driving the inertial fusion target in accordance with one or more natural localized spectra of a plasma to be formed from the inertial fusion target.

### RELATED APPLICATIONS

This application claims benefit of and priority to U.S. Provisional Patent Application No. 63/760,917 filed February 20, 2025 and titled "INERTIAL FUSION ENERGY GENERATION SYSTEMS AND METHODS," the entirety of which is hereby incorporated by reference.

### FIELD

Embodiments relate generally to energy generation, and more particularly to target structures and drive mechanisms for generation of inertial fusion energy.

### BACKGROUND

Inertial fusion energy generation involves the compression and heating of a nuclear fusion fuel to conditions sufficient to initiate nuclear fusion reactions. Such systems typically include a fusion target containing nuclear fusion fuel, together with one or more drive mechanisms adapted to deliver energy to the target in a controlled manner. The drive mechanisms may deliver energy in various forms, including electromagnetic energy, particle energy, or electrical current, to cause the target to implode and thereby increase fuel density and temperature. The specific structure of the target and the manner in which energy is delivered can significantly influence the behavior of the plasma formed during implosion and the resulting fusion performance.

### SUMMARY

Techniques for inertial fusion target design and drive are typically categorized into two general classes. The first class involves pulsed-power drive that generates large currents and results in correspondingly large magnetic fields. The targets typically exhibit a cylindrical symmetry and are imploded by magnetic pressure from a magnetic field with a single helical configuration. The target may include Deuterium-Tritium gas heated by a laser to a high temperature of about 300 eV, surrounded by a cylindrical shell of Deuterium-Tritium ice at 4 K, and further surrounded by a Beryllium cylinder. The cylinder may, for example, have a height to diameter ratio of about 1:2, (e.g., it may be a centimeter high and 5 mm in diameter). A magnetic field with helicity may be generated by driving current through external coils, with an even larger current passing through the Beryllium cylinder. Extreme care is typically taken to make the target and drive as cylindrically symmetric as possible, to inhibit the growth of instability that could disrupt the implosion. Despite efforts to preserve the cylindrical symmetry, the target has been observed to evolve into a double helical structure (e.g., as shown and described with regard to at least FIG. 1 and FIG. 2).

There is evidence that this class of pulsed-power driven inertial fusion may demonstrate an inverse turbulent cascade into a large-scale, self-organized structure. Two-dimensional (2D) MHD simulations have shown an inverse cascade into two stable vortices. Certain experiments have tracked a mode merger, characteristic of an inverse cascade. For example, experiments related to the MagLIF concept, have provided several indications of self-organization. There has been significant variation in yield for nominally similar experiments. This variation is likely due to small random variations in the target and drive that influence the natural localized spectra. Higher performance has been shown for targets that exhibit greater linear instability, as the natural, stable local spectra may grow faster. There has been relatively poor performance in dielectric-coated targets, which inhibit the growth of linear instabilities. This is likely because the natural localized spectra grow more slowly. Also, experiments have been observed to evolve into a double helical structure with convergence ratios greater than 200 - indicating a large-scale self-organized structure.

The second class involves a laser drive of spherically symmetric targets. The targets may be imploded by either radiation pressure (indirect drive) or fluid pressure (direct drive). The targets can include Deuterium-Tritium wetted foam surrounded by a spherical shell of Deuterium-Tritium ice, which is further surrounded by a CH plastic shell. Again, extreme care is typically taken to make the target and drive as spherically symmetric as possible in order to inhibit the growth of instability that could disrupt the implosion. However, it has proven challenging to maintain the implosion long enough, before it is disrupted. Two-dimensional (2D), azimuthally (cylindrically) symmetric simulations, where the plasma is driven with a strong dipole (1=2) asymmetry, have indicated that the system tends to evolve into two sets of two counter-rotating vortices - forming a quadrupole (1=4) structure, which has been observed to be very stable (e.g., as shown and described here with regard to at least FIG. 3). In three dimensions (3D), the target has been predicted to evolve to two counter-rotating double helical structures (e.g., as shown and described with regard to at least FIG. 4). Similar stability limitations may arise in cylindrical or other non-spherical target geometries driven by, for example, laser or pulsed-power systems.

Both of these classes of inertial fusion target design and drive attempt to force the plasma to evolve in a way that differs from its natural, stable evolution. Recent advances in computational modeling techniques have demonstrated methods for identifying the natural localized spectra of the plasma, allowing the plasma to be driven in a manner that aligns with its natural evolution rather than suppressing or counteracting that evolution.

Collective systems, sometimes referred to as "complex" systems, can include collectives or ensembles of conservatively interacting entities. In such systems, it may be that what one individual loses, others gain. This does not necessarily exclude the possibility of external interactions. Although these systems may be described generally using mathematical or physical formalisms (e.g., analytic, holomorphic, or complex), they can also display simple emergent behaviors - for example, they may exhibit natural localized spectra. Complex systems can take many different forms. A plasma may, for example, be a collective system of charged particles, a fluid may be, for example, a collective system of molecules, and an elementary field may be, for example, a collective system of elementary particles. In the context of this disclosure and certain embodiments, the targets generating nuclear fusion energy are classified as plasmas.

Described are techniques that drive the plasma toward optimum performance and enhance stability of the plasma against disruption. Certain embodiments employ a trained computational model to identify the natural localized spectra of the plasma and utilize natural localized spectra to drive the plasma toward optimum performance and enhance stability of the plasma against disruption. In some instances, the natural localized spectra manifest as simple emergent behaviors, which may include, for example, self-organization or BGK modes within the plasma.

The origin of self-organization such as these may be rooted in topology. The fields of the plasma, whether magnetic or fluid, may be entangled by the way in which the plasma is driven. Plasmas can, for example, become knotted. In such an instance, the plasma may then relax, where the plasma may lose energy but remain entangled. This may be equivalent to pulling strings so that a compact knot is formed, (e.g., as shown and described with regard to at least FIG. 9). Knowing how the strings are entangled - in other words, knowing how the knot is tied - corresponds to understanding the topology of the field of the plasma. Knowing how to drive the plasma may be analogous to knowing how to tie the knot. The plasma may then naturally implode to compress the entangled plasma (a plasma "knot") as compactly as possible.

Described are systems and techniques for inertial fusion energy generation that leverage naturally occurring modes of plasma organization to enhance confinement, stability, and energy yield. In certain embodiments, a fusion system includes a physical fusion target having multiple material regions arranged about a central axis and a drive system configured to deliver energy to the target in a manner that promotes the formation of self-organized plasma structures during implosion by driving the target in accordance with one or more natural localized spectra of a plasma to be formed from the target .

In some embodiments, the fusion target includes an inner region containing an igniter fuel, one or more surrounding regions containing nuclear fusion fuel, and an outer region formed of a material selected to support delivery of drive energy and associated fields. The geometry, material properties, and relative arrangement of these regions may be selected to encourage plasma evolution toward one or more natural localized spectra, including double helical and possibly counter-rotating double helical structures, during compression.

In some embodiments, the system further includes one or more drive mechanisms configured to apply energy to the target using electromagnetic radiation, electrical current, or a combination thereof. The applied energy may generate magnetic fields and associated forces that increase in strength as the target implodes, thereby promoting confinement of the plasma and supporting sustained fusion conditions, including confinement within a self-organized structure corresponding to the natural localized spectra.

In certain embodiments, a method of assembling a fusion target includes forming concentric or nested structural regions of selected materials, introducing one or more nuclear fusion fuels into the target, and configuring one or more drive interfaces to couple energy into the target in accordance with one or more natural localized spectra associated with a desired plasma evolution. In some embodiments, a method of operating the system includes applying drive energy to the assembled target so as to initiate implosion, induce self-organization of the plasma, and produce fusion energy.

In some embodiments, provided are techniques that involve the design and drive of an inertial fusion target based on the natural localized spectra. In certain embodiments, a trained computational model is used to determine the natural localized spectra. In some embodiments, the natural localized spectra are identified through simulation or experiment, where pulsed-power driven targets exhibit a double helical structure, and laser driven targets exhibit two counter-rotating double helical structures. In certain embodiments, the target is designed and driven in accordance with the natural localized spectra. The natural localized spectra may include helical, counter-rotating helical, toroidal, poloidal, spherical harmonic, or other mode structures arising under the geometry and boundary conditions of the target, and embodiments are not limited to any particular symmetry or coordinate system.

In some embodiments, laser drive involves driving the implosion with magnetic pressure generated by magnetic fields that result from the absorption of the laser energy, via the Biermann battery effect. This effect may be driven by the thermal, and corresponding electron pressure gradients, arising from the absorption of the laser energy. An advantage of using magnetic pressure drive, rather than radiation or fluid pressure drive, for example, may be that the magnetic pressure increases as the target implodes since the magnetic field flux is conserved. In some embodiments, when the target is driven properly, it can develop a significant amount of magnetic helicity. This may allow the target to evolve into a simple and compact self-organized structure. The confinement into such self-organized structure may be attributed to, for example, the redirection by the vector cross product nature of the magnetic force. Here, the vector cross-product nature of the magnetic force may redirect particle motion perpendicular to the applied force, thereby promoting confinement of the plasma within the evolving structure. As one might observe with a merry-go-round on the playground, the redirection of the cross product by 90 degrees may cause an attempted step off of the merry-go-round to be redirected sideways, resulting in a circular motion (e.g., walking) around the merry-go-round, thereby effectively keeping the motion confined to the merry-go-round.

In some embodiments, phase plates are employed to generate four laser patterns that form the structure of two counter-rotating double helices. In certain embodiments, phase plates are employed to generate four laser patterns that form the structure of a double helix corresponding to the natural localized spectra. In some embodiments, the base target includes a low density igniter fuel inside a cylindrical shell of solid nuclear fusion fuel, which is further enclosed within a cylindrical shell of low atomic number solid material forming a pusher material. In certain embodiments, the low density igniter fuel is Deuterium-Tritium (DT) gas or DT wetted foam, the solid-density nuclear fusion fuel is DT ice or an efficient solid at room temperature fuel such as Lithium-6-Deuteride (Li6D) or Hydrogen-Boron-11 (HB11), and the low atomic number solid material is Beryllium (Be) or CH plastic. In some embodiments, the cylindrical shells are sculpted to drive the natural localized spectra. In certain embodiments, there are current return paths across the top and bottom of the cylindrical shells, or from the top to the bottom of the cylindrical shells to define a conductive loop corresponding to the natural localized spectra. In some embodiments, a trained computational model is employed to determine the initial conditions, dimensions, and sculpting of the target and associated drive patterns. In some embodiments, a target includes: a low density igniter fuel, a cylindrical shell of solid-density nuclear fusion fuel surrounding the low density igniter fuel; and a cylindrical shell of solid pusher material (that in some embodiments may have a low atomic number) surrounding the cylindrical shell of solid-density nuclear fusion fuel, where the target is driven using natural localized spectra. In some embodiments, the low density igniter fuel includes Deuterium-Tritium (DT) gas; or Deuterium-Tritium (DT) wetted foam. In certain embodiments, the solid-density nuclear fusion fuel includes: Deuterium-Tritium (DT) ice; efficient, solid at room temperature, fuel; Lithium-6-Deuteride (Li6D); or Hydrogen-Boron-11 (HB11). In some embodiments, the solid pusher material includes: Beryllium (Be) or CH plastic. In certain embodiments, drive corresponding to the natural localized spectra: is determined by a trained computational model; is determined by simulation or experimental observation; includes a double helical pattern; or includes two counter-rotating double helical patterns. In some embodiments, the drive is provided by magnetic pressure generated by: absorption of laser energy; or absorption of energy from lasers with phase plates; or pulsed-power, to provide a desired pattern corresponding to the natural localized spectra. In certain embodiments, a return current path is provided: across a top and a bottom of the cylindrical shell; or from the top to the bottom of the cylindrical shell to complete a conductive path corresponding to the natural localized spectra. In some embodiments, the cylindrical shells are sculpted to drive the target using natural localized spectra. In certain embodiments, an artificial intelligence model employing a trained computational model is used to determine: initial conditions; dimensions; or sculpting of the target and/or laser energy to correspond to the natural localized spectra. In some embodiments, the target includes any combination of the features described.

Provided in some embodiments is a fusion energy generation system, including: an inertial fusion target including: an inner fuel disposed in an interior region of the target; a cylindrical shell of outer fuel surrounding the inner fuel; and a cylindrical shell of pusher material surrounding the cylindrical shell of outer fuel; and a drive system adapted to drive the inertial fusion target in accordance with one or more natural localized spectra of a plasma to be formed from the inertial fusion target.

In some embodiments, the drive system includes a laser system adapted to drive the inertial fusion target. In some embodiments, the laser system includes one or more lasers and one or more phase plates adapted to produce the one or more natural localized spectra. In some embodiments, the drive system includes a pulsed power system adapted to drive the inertial fusion target. In some embodiments, the pulsed power system includes a pulsed power source adapted to drive current through the cylindrical shell of the pusher material, and the cylindrical shell of the pusher material is shaped to produce the one or more natural localized spectra. In some embodiments, the drive system is adapted to drive the cylindrical shell of the pusher material in one or more double helical patterns corresponding to the one or more natural localized spectra. In some embodiments, the inertial fusion target is adapted to be driven by magnetic pressure generated by: absorption of laser energy; absorption of energy from lasers with phase plates; or pulsed power. In some embodiments, the inner fuel includes a nuclear fusion fuel material having a density lower than the density of the outer fuel and that is adapted to initiate nuclear fusion reactions within the target. In some embodiments, the inner fuel includes a Deuterium-Tritium gas or a Deuterium-Tritium wetted foam. In some embodiments, the outer fuel includes a nuclear fusion fuel material in a solid state and has a density greater than the density of the inner fuel. In some embodiments, the outer fuel includes Deuterium-Tritium ice, an efficient solid at room temperature fuel, Lithium-6-Deuteride, or Hydrogen-Boron-11. In some embodiments, the pusher material includes a solid material having an average atomic number lower than ten. In some embodiments, the pusher material includes Beryllium or a Carbon-Hydrogen plastic. In some embodiments, the one or more natural localized spectra are determined by applying characteristics of the inertial fusion target to a trained computational model that is trained to determine the oneor more natural localized spectra based on characteristics of the inertial fusion target.

Provided in some embodiments is a fusion energy generation method, the method including: providing an inertial fusion target including: an inner fuel disposed in an interior region of the target; a cylindrical shell of outer fuel surrounding the inner fuel; and a cylindrical shell of pusher material surrounding the cylindrical shell of outer fuel; and driving the inertial fusion target in accordance with one or more natural localized spectra of a plasma to be formed from the inertial fusion target.

In some embodiments, driving the inertial fusion target includes driving the inertial fusion target using a laser system. In some embodiments, the laser system includes one or more lasers and one or more phase plates that produce the one or more natural localized spectra. In some embodiments, driving the inertial fusion target includes driving the inertial fusion target using a pulsed power system. In some embodiments, the pulsed power system includes a pulsed power source that drives current through the cylindrical shell of the pusher material, and the cylindrical shell of the pusher material is shaped to produce the one or more natural localized spectra. In some embodiments, the drive system is adapted to drive the cylindrical shell of the pusher material in one or more double helical patterns corresponding to the one or more natural localized spectra. In some embodiments, the method including obtaining energy generated by way of the driving of the inertial fusion target.

Provided in some embodiments is an energy generation system, including: an inertial fusion target including: an inner fuel disposed in an interior region of the target; an outer fuel surrounding the inner fuel; and a pusher material surrounding the outer fuel; and a drive system adapted to drive the inertial fusion target in accordance with one or more natural localized spectra of a plasma to be formed from the inertial fusion target. In some embodiments, the drive system is adapted to drive the pusher material in one or more double helical patterns corresponding to the one or more natural localized spectra.

Provided in some embodiments is a method of energy generation, the method including: driving an inertial fusion target in accordance with one or more natural localized spectra of a plasma to be formed from the inertial fusion target, the inertial fusion target including: an inner fuel disposed in an interior region of the target; an outer fuel surrounding the inner fuel; and a pusher material surrounding the outer fuel. In some embodiments, driving the inertial fusion target includes driving the pusher material in one or more double helical patterns corresponding to the one or more natural localized spectra.

### BRIEF DESCRIPTION OF THE DRAWINGS

FIG. 1 is a diagram that illustrates natural localized spectra, including a double helix, in accordance with one or more embodiments.

FIG. 2 is a diagram that illustrates a resulting structure of a double helix in accordance with one or more embodiments.

FIG. 3 is a diagram that illustrates the azimuthally symmetric quadrupole pattern in accordance with one or more embodiments.

FIG. 4 is a diagram that illustrates a resulting structure of two counter-rotating double helices in accordance with one or more embodiments.

FIG. 5 is a diagram that illustrates a drive system operable to drive the target with two counter-rotating double helices in accordance with one or more embodiments.

FIG. 6 is a diagram that illustrates a drive system operable to drive the target with a double helix in accordance with one or more embodiments.

FIG. 7 is a diagram that illustrates the base target design in accordance with one or more embodiments.

FIG. 8 is a diagram that illustrates two current return paths in accordance with one or more embodiments.

FIG. 9 is a diagram that illustrates the entanglement of the magnetic field in accordance with one or more embodiments.

FIG. 10 is a flowchart diagram that illustrates a method of operating an inertial fusion system in accordance with one or more embodiments.

FIG. 11 is a diagram that illustrates an example computer system in accordance with one or more embodiments.

While this disclosure is susceptible to various modifications and alternative forms, specific example embodiments are shown and described. The drawings may not be to scale. The drawings and the detailed description are not intended to limit the disclosure to the form disclosed, but are intended to disclose modifications, equivalents, and alternatives falling within the spirit and scope of the present disclosure as defined by the claims.

### DETAILED DESCRIPTION

Described are techniques that drive the plasma toward optimum performance and enhance stability of the plasma against disruption. Certain embodiments employ a trained computational model to identify the natural localized spectra of the plasma and utilize natural localized spectra to drive the plasma toward optimum performance and enhance stability of the plasma against disruption. In some instances, the natural localized spectra manifest as simple emergent behaviors - including, for example, self-organization or BGK modes within the plasma.

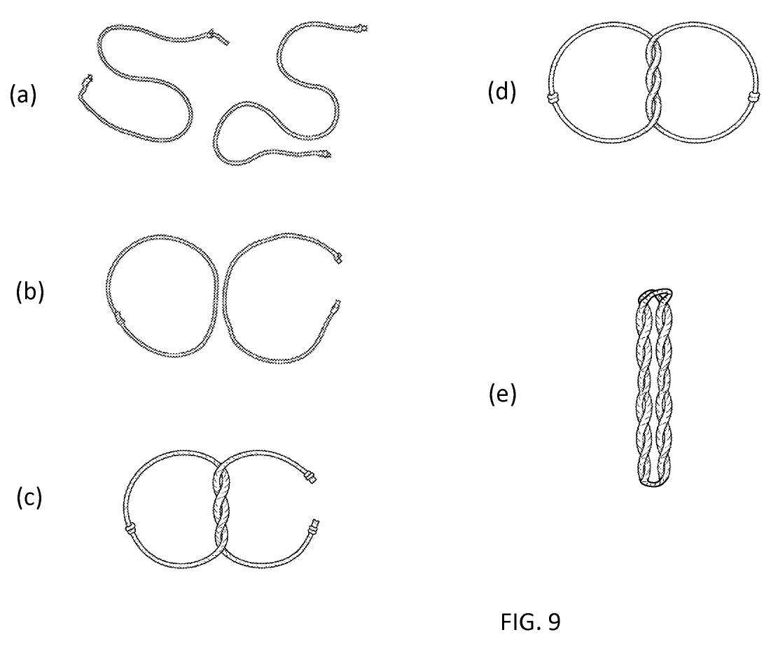

The origin of self-organization such as these may be rooted in topology. The fields of the plasma, whether magnetic or fluid, may be entangled by the way in which the plasma is driven. Plasmas can, for example, become knotted. In such an instance, the plasma may then relax, where the plasma may lose energy but remain entangled. This may be equivalent to pulling strings so that a compact knot is formed (e.g., as shown and described with regard to at least FIG. 9). Knowing how the strings are entangled - in other words, knowing how the knot is tied - corresponds to understanding the topology of the field of the plasma. Knowing how to drive the plasma may be analogous to knowing how to tie the knot. The plasma may then naturally implode to compress the entangled plasma (a plasma "knot") as compactly as possible.

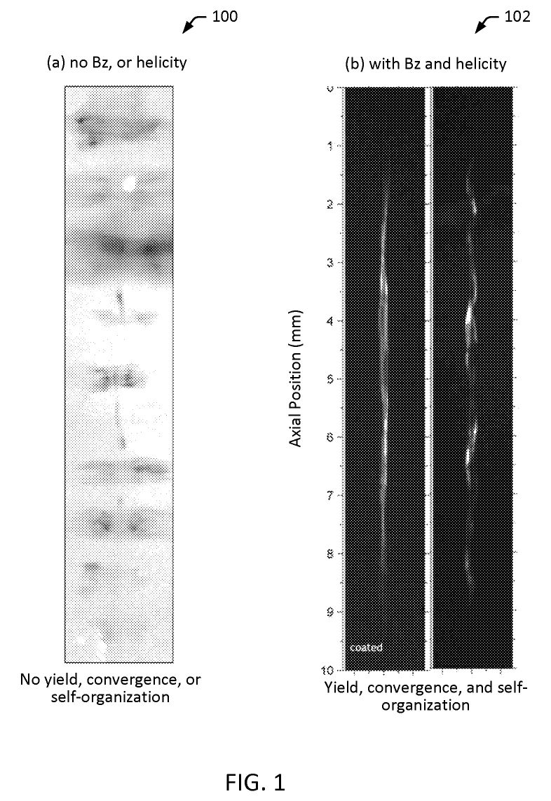

FIG. 1 is a diagram that illustrates the natural localized spectra, an example of a double helix, in accordance with one or more embodiments. For example, illustrated is x-ray self-emission from stagnated, imploded plasma of a pulsed-power driven MagLIF target. In part (a), shown is a self-emission image 100 where there is no axial magnetic field, e.g., no magnetic helicity or entanglement of the field. Note that the plasma is not confined in this embodiment, and the plasma jets out. In part (b), shown are two self-emission images 102 where there is a significant axial magnetic field, e.g., significant magnetic helicity or entanglement of the magnetic field. This may be both for a coated liner, meant to maintain azimuthal symmetry, and an uncoated liner. Note that the plasma is confined, despite being compressed, e.g., by a factor of more than 200. Despite the effort to maintain azimuthal symmetry, the plasma displays the double helical structure.

As used herein, "natural localized spectra" may refer to one or more stable, localized modes of plasma organization that arise intrinsically from the plasma dynamics under given initial conditions and geometry. "Natural localized spectra" may correspond to one or more intrinsic eigenmodes, coherent structures, or dynamically preferred mode structures of the plasma determined by the plasma's governing equations (e.g., magneto-hydrodynamic equations), boundary conditions, geometry, material properties, and initial conditions. These spectra may be characterized by identifiable spatial mode numbers, symmetry orders, helicity, topology, vorticity patterns, current distributions, or magnetic field configurations that exhibit enhanced growth rate, nonlinear saturation stability, or self-organization relative to other accessible modes. In some embodiments, the natural localized spectra are identified as dominant modes in a modal decomposition of plasma state variables, including density, pressure, velocity, current density, or magnetic field, obtained from simulation or experimental diagnostics.

As used herein, "driving" a target or plasma refers to the application of energy, current, electromagnetic radiation, magnetic field, electric field, or combinations thereof to the target so as to induce implosion, compression, heating, current flow, magnetic field generation, or plasma motion. Driving may include depositing energy into a pusher material, passing current through a conductive structure of the target, generating magnetic pressure, shaping energy deposition spatially or temporally, or otherwise imposing boundary conditions that influence plasma evolution. Driving "in accordance with" one or more natural localized spectra refers to configuring at least one drive parameter - including spatial distribution, symmetry order, azimuthal mode number, helical pitch, current path geometry, timing, amplitude, or phase - so that the applied drive preferentially promotes growth or formation of the identified natural localized spectra relative to alternative plasma modes.

In this context, driving a target "in accordance with" one or more natural localized spectra includes configuring one or more drive parameters such that the imposed energy deposition, current distribution, or magnetic field topology is selected to promote evolution of the plasma toward the identified intrinsic mode rather than toward an externally imposed symmetric state. Such configuration may include selecting spatial distribution, symmetry order, helical pitch, azimuthal mode number, phase, timing, amplitude, or combinations thereof to substantially align with corresponding characteristics of the identified natural localized spectra. Correspondence need not require exact mathematical identity; rather, the drive may be configured so that the growth rate, stability, or preferential formation of the identified natural localized spectra is enhanced relative to alternative plasma modes under comparable conditions.

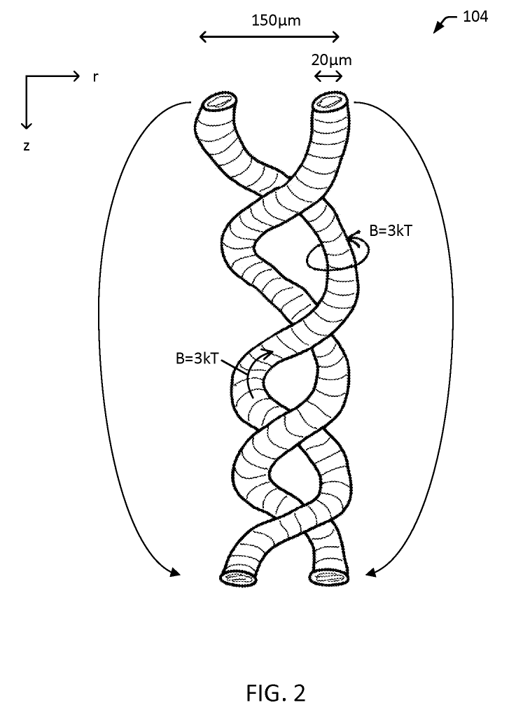

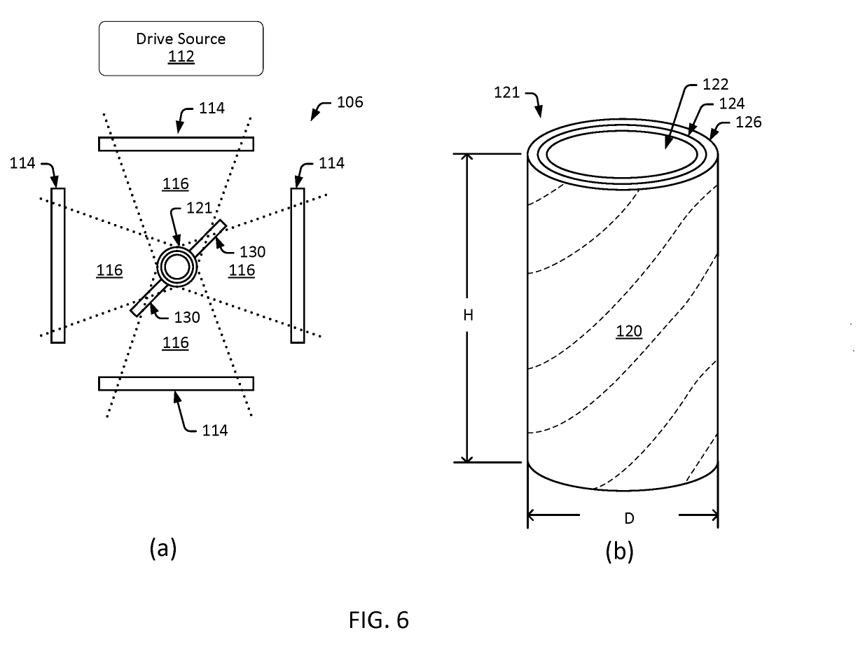

FIG. 2 is a diagram that illustrates a resulting structure of a double helix 104 in accordance with one or more embodiments. Shown is the resulting structure of the double helix, resulting, for example, from a drive system shown in FIG. 6, which is a diagram that illustrates a drive system 106 operable to drive the target with a double helix in accordance with one or more embodiments.

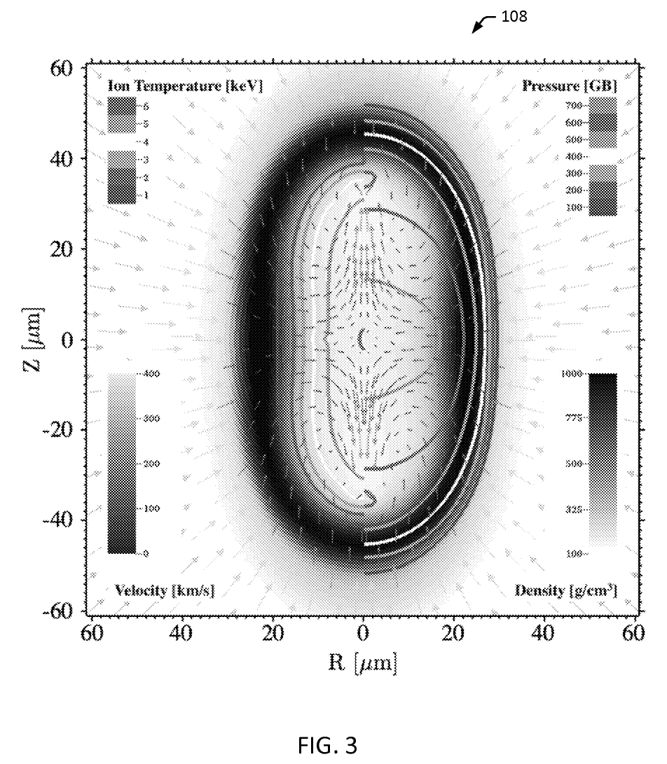

FIG. 3 is a diagram that illustrates the azimuthally symmetric quadrupole pattern 108 in accordance with one or more embodiments. Shown is an azimuthally (cylindrically) symmetric quadrupole (1=4) structure of two sets of two counter-rotating vortices, resulting from driving the plasma with a laser with a dipole (1=2) asymmetry.

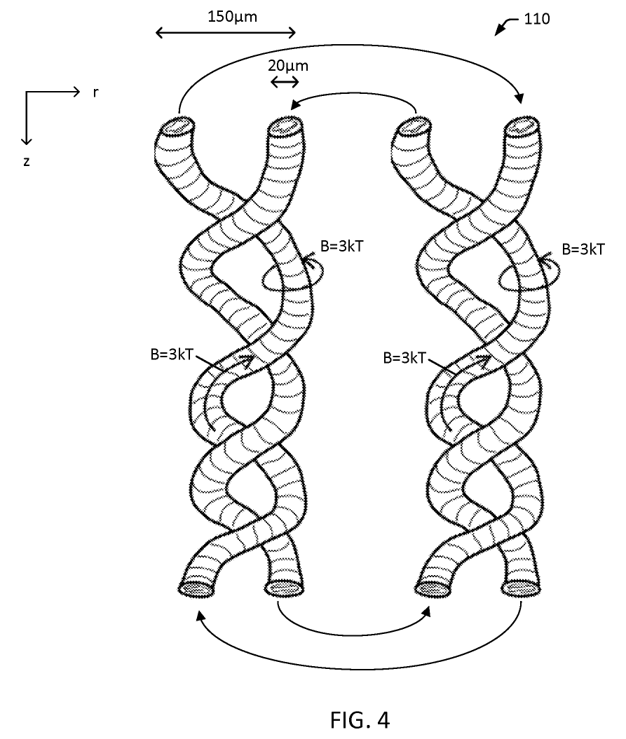

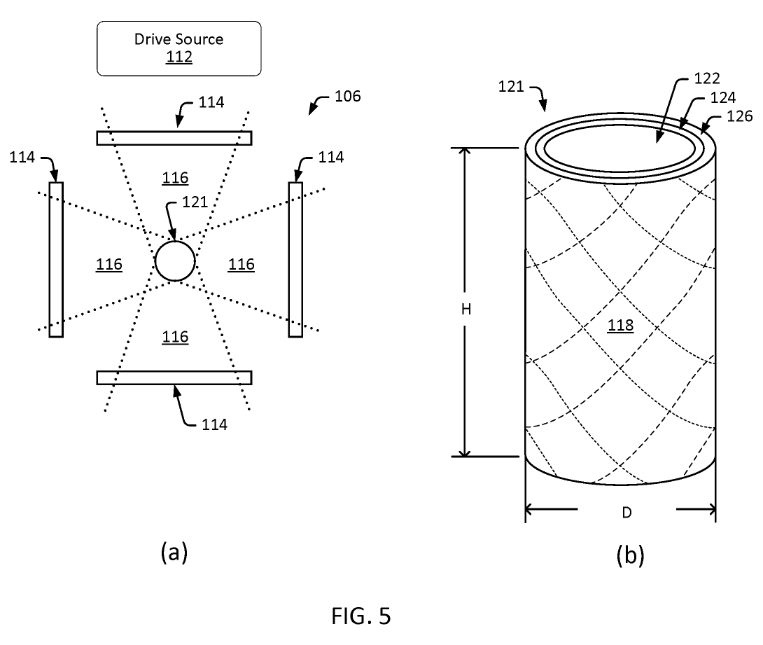

FIG. 4 is a diagram that illustrates a resulting structure of two counter-rotating double helices 110 in accordance with one or more embodiments. Shown is a resulting structure of two counter-rotating double helices, for example, resulting from the drive system 106 shown in FIG. 5, which is a diagram that illustrates a drive system that is operable to drive the target with two counter-rotating double helices in accordance with one or more embodiments. As described, FIG. 6 is a diagram that illustrates a drive system operable to drive the target with a double helix in accordance with one or more embodiments.

In some embodiments, provided are techniques that involve the design and drive of an inertial fusion target based on the natural localized spectra. In certain embodiments, a trained computational model is used to determine the natural localized spectra. In some embodiments, the natural localized spectra are identified through simulation or experiment, where pulsed-power driven targets exhibit a double helix, and laser driven targets exhibit two counter-rotating double helical structures. In certain embodiments, the target is designed and driven in accordance with the natural localized spectra. The natural localized spectra may include helical, counter-rotating helical, toroidal, poloidal, spherical harmonic, or other mode structures arising under the geometry and boundary conditions of the target, and embodiments are not limited to any particular symmetry or coordinate system.

In certain conventional pulsed-power driven inertial confinement fusion (ICF) systems, a cylindrical target includes a laser-preheated Deuterium-Tritium (DT) gas inner fuel that functions as an igniter for a surrounding cylindrical DT ice outer fuel, which is further enclosed within a Beryllium (Be) pusher material and includes one or more current return paths. Such systems are typically driven by large currents producing magnetic pressure with nominal cylindrical symmetry and may achieve compression ratios on the order of 200. In contrast, in certain embodiments described herein, a pulsed-power driven cylindrical target is driven in accordance with one or more natural localized spectra, such as a double helical mode, such that the plasma evolves into a twisted pair structure rather than a nominally symmetric configuration.

In certain conventional laser-driven ICF systems, a spherical target includes a DT wetted CH foam inner fuel surrounded by a spherical DT ice outer fuel and a CH plastic pusher material, and is driven with nominal spherical symmetry by ablation pressure (direct drive) or radiation pressure (indirect drive), typically with compression ratios on the order of 10 and with shock pre-heating of the inner fuel. In contrast, certain embodiments described herein employ drive patterns corresponding to one or more natural localized spectra, including two counter-rotating double helical modes, and may further include cylindrical or hybrid cylindrical-spherical target geometries, room-temperature DT gas igniters, radial cylindrical burn of the outer fuel, room-temperature Lithium-6-Deuteride (Li6D) outer fuel, magnetic pressure drive, elimination of a return path in laser embodiments, reduction of turbulent mix due to self-organization, and reduced laser access requirements. In certain embodiments, a laser-driven implementation may provide practical advantages for reactor operation, including standoff drive and high repetition rate capability.

In some embodiments, laser drive involves driving the implosion with magnetic pressure generated by magnetic fields that result from the absorption of the laser energy, via the Biermann battery effect. This effect may be driven by the thermal, and corresponding electron pressure gradients, arising from the absorption of the laser energy. An advantage of using magnetic pressure drive, rather than radiation or fluid pressure drive, for example, may be that the magnetic pressure increases as the target implodes since the magnetic field flux is conserved. In some embodiments, when the target is driven properly, it can develop a significant amount of magnetic helicity. This may allow the target to evolve into a simple and compact self-organized structure. The confinement into such self-organized structure may be attributed to, for example, the redirection by the vector cross product nature of the magnetic force. Here, the vector cross-product nature of the magnetic force may redirect particle motion transverse to the applied force, thereby promoting confinement of the plasma within the evolving structure. As one might observe with a merry-go-round on the playground, the redirection of the cross product by 90 degrees may cause an attempted step off of the merry-go-round to be redirected sideways, resulting in a circular motion (e.g., walking) around the merry-go-round, thereby effectively keeping the motion confined to the merry-go-round.

In some embodiments, a drive system 106, such as that of FIG. 5 or FIG. 6, is employed to drive the inertial fusion target, for example, in accordance with natural localized spectra of a plasma to be formed from the inertial fusion target. Part (a) of each provides a top view and part (b) shows a side view of the corresponding cylindrical target 121 and the drive pattern (e.g., two counter-rotating double helices 118 or a double helix 120). In the illustrated embodiments, the drive system 106 includes a drive source 112 and phase plates 114. In such an embodiment, the drive source 112 may include one or more lasers and phase plates 114 may be operable to shape the laser output into desired laser pattern. For example, referring to part (a) of FIG. 5, the phase plates 114 may be sized, shaped, positioned, or otherwise employed to generate four laser patterns 116 that form the structure of two counter-rotating double helices 118, for example, as shown in part (b) of FIG. 5. An example result of this configuration is shown in FIG. 4. As another example, referring to part (a) of FIG. 6, the phase plates 114 may be sized, shaped, positioned, or otherwise employed to generate four laser patterns 116 that form the structure of a double helix 120, for example, as shown in part (b) of FIG. 6. An example result of this configuration is shown in FIG. 2.

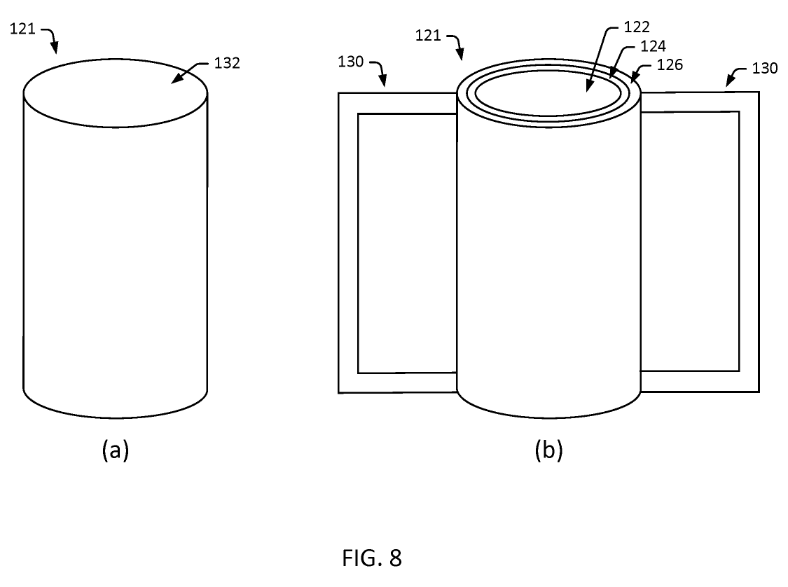

In some embodiments, the drive system may be a laser drive system, a pulsed power drive system, or the like. For example, as described with reference to at least FIG. 5 and FIG. 6, the drive source 112 may include one or more lasers that are used to produce the desired drive pattern (e.g., two counter-rotating double helices 118 or a double helix 120) that is projected on the outer surface of the target 121. As described, this may be accomplished by way of phase plates 114 that are used to shape the laser output into desired laser pattern. In the case of the drive system being a pulsed power drive system, the drive source 112 may include a power driver that is operable to provide pulses of power, and that is connected in line with an electrically conductive loop (e.g., in the middle of each of the current return paths 130 shown in FIG. 8) that produce the desired drive pattern (e.g., two counter-rotating double helices 118 or a double helix 120) on the target 121. In such an embodiment, the conductive path may be defined by physical electrical lines that are disposed on or in the outer fuel 126 of the target 121 in desired pattern (e.g., two counter-rotating double helices 118 or a double helix 120). When the power driver is operated to drive pulses of power on the electrical lines, the power may be imparted to the outer fuel 126 of the target 121 in the desired drive pattern (e.g., two counter-rotating double helices 118 or a double helix 120). For example, as described here, the target 121 may be an inertial fusion target formed of an inner fuel disposed in an interior region of the target, a cylindrical shell of outer fuel surrounding the inner fuel, and a cylindrical shell of pusher material surrounding the cylindrical shell of outer fuel, and the drive system 106 (e.g., one or more laser or pulsed power type drive sources 112) may be operated to drive the inertial fusion target in accordance with natural localized spectra of a plasma to be formed from the inertial fusion target - this may include providing a drive pattern (e.g., two counter-rotating double helices 118 or a double helix 120) that is determined (e.g., by way of computer modeling) to correspond to the natural localized spectra of a plasma to be formed from the inertial fusion target. Embodiments may employ any drive mechanism adapted to impose a pattern corresponding to one or more natural localized spectra.

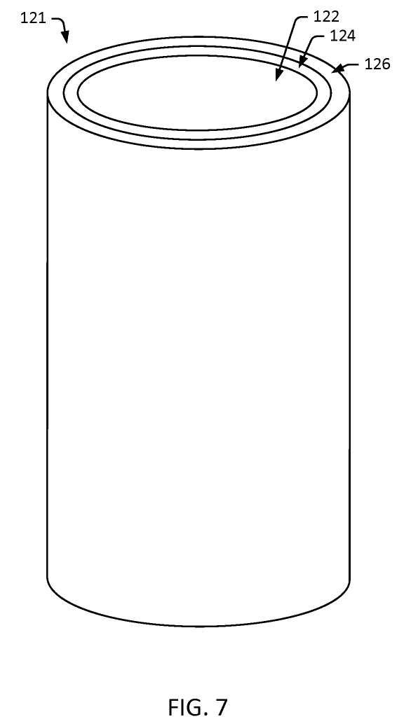

In some embodiments, the base target 121 includes an inner fuel 122 (e.g., a cylinder of low density igniter fuel), inside an outer fuel 124 (e.g., a cylindrical shell of solid-density nuclear fusion fuel), which is further enclosed within a pusher material 126 (e.g., a cylindrical shell of low atomic number solid material), as shown in FIG. 7, which is a diagram that illustrates an example design of the base target 121 in accordance with one or more embodiments.

In certain embodiments, inner fuel 122 (e.g., the low density igniter fuel) is Deuterium-Tritium (DT) gas or DT wetted foam, the outer fuel 124 (e.g., the solid-density nuclear fusion fuel) is DT ice or an efficient solid at room temperature fuel such as Lithium-6-Deuteride (Li6D) or Hydrogen-Boron-11 (HB 11), and the pusher material 126 (e.g., low atomic number solid material) is Beryllium (Be) or CH plastic). In some embodiments, the pusher material is sculpted to drive the natural localized spectra. The pusher material is sculpted by varying the thickness of the cylinder so that the current follows the double helix 120. In certain embodiments, there are current return paths 130 across the top and bottom of the cylindrical shells, and from the top to the bottom of the cylindrical shells, as shown in FIG. 8. The return path provides a contiguous electrically conductive path that closes the current circuit into a loop.

FIG. 8 is a diagram that illustrates two current return paths 130 in accordance with one or more embodiments. Shown are two current return paths 130. Part (a) shows caps 132 (e.g., formed of Be) across the top and the bottom which may be used for driving two counter-rotating double helices. Part (b) shows a return circuit (including the two current return paths 130) from the top to the bottom of the external layer (e.g., the pusher material 126) of the target 121, which may be used to drive a double helix.

FIG. 9 is a diagram that illustrates the entanglement (e.g., the knotting or topology) of the magnetic field in accordance with one or more embodiments. This demonstrates an example of the entanglement, that is, the knotting or topology, of the magnetic field using two strings. Part (a) shows two strings. Part (b) shows one of the strings tied together making a loop. Part (c) shows the second string twisted around the first string. Part (d) shows the second string tied into a loop, leading to the double helix, such as that shown in FIG. 2. Part (e) shows the strings manipulated to yield two counter-rotating double helices, such as that shown in FIG. 4.

In some embodiments, a trained computational model is employed to determine the initial conditions, dimensions, and sculpting of the target and laser energy. In some embodiments, the trained computational model is Generative Artificial Intelligence. In some embodiments, the computational model is a radiation magneto-hydrodynamic computer simulation. In some embodiments, the computational model includes algorithms to optimize the performance by determining the best initial conditions, target dimensions, and pattern of the pusher material and laser energy.

In some embodiments, a target includes: a low density igniter fuel, a cylindrical shell of solid-density nuclear fusion fuel surrounding the low density igniter fuel; and a cylindrical shell of low atomic number solid material surrounding the cylindrical shell of solid-density nuclear fusion fuel, where the target is driven using natural localized spectra.

In some embodiments, the low density igniter fuel includes Deuterium-Tritium (DT) gas; or Deuterium-Tritium (DT) wetted foam. In certain embodiments, the solid-density nuclear fusion fuel includes: Deuterium-Tritium (DT) ice; efficient, solid at room temperature, fuel;

Li6D; or HB11.

In some embodiments, the low atomic number solid material includes: Beryllium (Be) or CH plastic. In certain embodiments, a drive corresponding to the natural localized spectra: is determined by a trained computational model; is determined by simulation or experimental observation; includes a double helical pattern; or includes two counter-rotating double helical patterns.

In some embodiments, the drive is provided by magnetic pressure generated by: absorption of laser energy; or absorption of energy from lasers with phase plates; or pulsed-power, to provide a desired pattern corresponding to the natural localized spectra .

In certain embodiments, a return current path is provided: across a top and a bottom of the cylindrical shell; or from the top to the bottom of the cylindrical shell to complete a conductive path corresponding to the natural localized spectra.

In some embodiments, the cylindrical shells are sculpted to drive the target using natural localized spectra.

In certain embodiments, a trained computational model is used to determine: initial conditions; dimensions; or sculpting of the target and laser energy to correspond to the natural localized spectra .

In some embodiments, the target includes any combination of the features described herein .

In further embodiments, the inertial fusion systems described herein are implemented using cylindrical or otherwise elongated fusion targets configured to support the development of helical plasma structures during implosion corresponding to one or more natural localized spectra. Such targets may include an inner igniter region, a surrounding nuclear fusion fuel region, and an outer structural region adapted to carry drive currents, support magnetic field generation, or both.

In some embodiments, the target is assembled by forming an outer structural shell, depositing or positioning a nuclear fusion fuel layer within the shell, and introducing an igniter fuel into a central region of the target. End structures or conductive features may be provided to define current return paths or other electrical characteristics that influence the distribution of magnetic fields during operation in accordance with one or more natural localized spectra.

In certain embodiments, a method of operating the target includes delivering energy to the target using one or more lasers, pulsed-power sources, or combinations thereof, optionally shaped or patterned to induce helical or counter-rotating helical plasma motion corresponding to one or more natural localized spectra. As the target implodes, magnetic pressure and associated forces may increase, guiding plasma motion and promoting confinement within a self-organized structure.

In some embodiments, parameters of the target geometry, material composition, and drive configuration are selected or determined based on computational modeling, experimental observation, or both, to encourage plasma evolution toward one or more natural localized spectra associated with enhanced stability and fusion performance.

In some embodiments, pusher material 126 (e.g., a cylindrical shell of low atomic number solid material) is constructed. For example, a cylindrical shell of Beryllium, e.g., with a height to diameter ratio of about 1:2, such as a diameter (D) of 5 mm, a height (H) of one centimeter, and having a thickness of 500 microns, is constructed. In some embodiments, an outer fuel 124 (e.g., a cylindrical shell of solid-density nuclear fusion fuel) is constructed. For example, the cylindrical shell of Beryllium may then be coated on the inside, e.g., with 200 microns of Lithium-6-Deuteride (Li6D). In some embodiments, an inner fuel 122 (e.g., the low density igniter fuel, typically with about 1/1000 the density of the outer fuel) is provided. For example, the hollow center of the Li6D may be filled with gas, e.g., Deuterium-Tritium gas (DT gas) at room temperature. In some embodiments, caps 132 are constructed. For example, further, the top and bottom of the cylindrical shell of Beryllium may be enclosed with respective caps, e.g., respective upper and lower Beryllium caps. In some embodiments, heating may be applied to an exterior of the assembled target 121 before, during or after it is driven. For example, lasers 116 may be activated to impinge on the sides of the cylinder, e.g., four lasers may impinge on the outer cylindrical surface of the target 121 positioned at 90 degree intervals. The lasers may, for example, have phase plates 114 that form two counter-rotating double helical structures, such as that shown in FIG. 5. The plasma may be driven to implode into two counter-rotating double helical structures, such as that shown in FIG. 4. The plasma is driven with the pattern of two counter-rotating double helical structures 118, so that it may form the self-organized structure of two twisted pairs 110. In such an embodiment, the DT gas may ignite and undergo volume burn, generating energy, e.g., up to 10 Mega-Joule (MJ) of energy. This energy release may serve as an igniter for the radial burn of the coating, e.g., burn of the Li6D, which may also generate energy, e.g., up to a 10 Giga-Joule (GJ) of energy.

In some embodiments, pusher material 126 (e.g., a cylindrical shell of low atomic number solid material) is constructed. For example, a cylindrical shell of Beryllium, e.g., with a diameter (D) of5 mm, a height (H) of one centimeter, and a thickness of 500 microns, with a double helical pattern 120, is constructed, which may be similar to that shown in part (b) of FIG. 6. In some embodiments, an outer fuel 124 (e.g., a cylindrical shell of solid-density nuclear fusion fuel) is constructed. For example, the cylindrical shell of Beryllium may then be coated on the inside, e.g., with 200microns of DT ice. In some embodiments, an inner fuel 122 (e.g., the low density igniter fuel, typically with about 1/1000 the density of the outer fuel) is provided. For example, the hollow center of the DT ice may be filled with gas, e.g., Deuterium-Tritium gas (DT gas), that is preheated, e.g., preheated up to 300 eV by a laser. In some embodiments, current return paths 130 are constructed. For example, Beryllium wires may be constructed to provide the current return paths. In some embodiments, a current is driven through the pusher material 126. For example, a current, e.g., a large current of 30 Mega-Amperes (MA), may be driven through the Beryllium helical shell, e.g., by a pulsed-power generator. The plasma may be driven to implode into a double helical structure, such as that shown in FIG. 2. The plasma is driven with the pattern of a double helical structure 120, so that it may form the self-organized structure of a twisted pair 104. In such an embodiment, the DT gas may ignite and undergo volume burn, generating energy, e.g., up to 10MJ of energy. This energy release may serve as an igniter for the radial burn of the coating, e.g., burn of the DT ice, which may also generate energy, e.g., up to a 10GJ of energy.

Accordingly, in some embodiments, provided is an inertial fusion energy generation system that includes: an inertial fusion target that includes: (a) an inner fuel disposed in an interior region of the target; (b) an outer fuel surrounding the inner fuel; and (c) a pusher material surrounding the outer fuel.

In some embodiments, the inertial fusion target can be driven in accordance with natural localized spectra of a plasma formed from the inner fuel, outer fuel, and pusher material. For example, driving with natural localized spectrum may include driving with four lasers 116, shaped with phase plates 114, so that they form a pattern of two counter-rotating double helical structures 118, so that the imploded plasma may form the compact self-organized structure of two twisted pairs 110.

In some embodiments, the inner fuel consists of or includes a fuel material having a density lower than a density of the outer fuel. For example, the inner fuel may have 1/1000 the density of the outer fuel. In some embodiments, the inner fuel is capable of initiating fusion reactions within the target. For example, initiating fusion reactions within the target may be the inner fuel being compressed so that it reaches temperatures high enough, e.g., 20 kilo-Volts (keV), so that the inner fuel undergoes thermo-nuclear fusion, yielding enough energy, e.g., 10 MJ, so that the burn propagates radially into the outer fuel, analogous to an ignition source initiating combustion in a surrounding material. As described, the inner fuel may consist of or otherwise include: a low density igniter fuel, or a Deuterium-Tritium (DT) gas, or a DT wetted foam.

In some embodiments, the outer fuel includes a nuclear fusion fuel material in a solid state and having a density greater than a density of the low density igniter fuel. For example, the outer fuel may be an efficient (e.g. releasing more than 1000 GJ/gm of energy when it undergoes thermo-nuclear fusion), solid (e.g., having a density of 3 gm/cc) at room temperature fuel. As described, the outer fuel may consist of or otherwise include: an efficient, solid at room temperature, fuel; or DT ice; or Li6D; or Hydrogen-Boron-11 (HB11).

In some embodiments, the pusher material includes a solid material having an atomic number of 10 or less. As described, the pusher material may consist of or otherwise include: a low atomic number solid material, or Beryllium (Be, which has an atomic number of 4), or a hydrocarbon-based material, such as CH plastic (carbon, C, has an atomic number of 6, and hydrogen, H, has an atomic number of 1).

In some embodiments, the target includes a current return path. For example, a current return path may be a path of conductivity that closes the current loop, that is reconnects or ties the string into a loop. As described, the current return path may consist of or otherwise include: a conductive return path across a top and a bottom of the cylindrical shell, or a conductive return path from the top to the bottom of the cylindrical shell.

In some embodiments, the natural localized spectra are determined using a trained computational model. For example, the trained computational model may be: Generative Artificial Intelligence, or a radiation magneto-hydrodynamic computer simulation. The models may be trained by input of experimental measurements, or by doing a number of computer simulations. The trained computational model may also include algorithms to optimize the performance by determining the best initial conditions, target dimensions, and pattern of the pusher material and laser energy, corresponding to the natural localized spectra.

In some embodiments, determining the natural localized spectra includes performing one or more computational simulations of the plasma evolution under specified target geometry, material composition, and drive conditions; extracting spatial or temporal mode structures from simulated plasma state variables; identifying dominant or stable modes based on growth rate, nonlinear persistence, or energy concentration; and selecting drive parameters that correspond to the identified dominant modes. In certain embodiments, determining the natural localized spectra includes a trained computational model, such as that describe here, receiving as inputs one or more of: target dimensions, material properties, fuel densities, drive energy magnitude, drive geometry, or boundary conditions, and outputs one or more parameters corresponding to the natural localized spectra, including symmetry order, azimuthal mode number, helical pitch, phase relationships, or current path geometry. Determination of natural localized spectra may includeexperimental diagnostics such as x-ray imaging, interferometry, magnetic probe measurements, or Doppler velocity mapping, followed by modal analysis of measured plasma state variables.

In some embodiments, driving the natural localized spectra comprises driving a double helical pattern. For example, a double helical pattern may be a twisted pair of strings that are closed into loops as shown in FIG. 9d. This double helical pattern, may appear as two stripes wrapping around forming a candy cane pattern 120, or may appear as two sets of two stripes that are counter-rotating, forming a double candy cane 118. For example, driving a double helical pattern may be achieved by shaping the pattern of the laser beams 116 with phase plates 114 into the two counter-rotating double helical patterns 118, or may be achieved by sculpting the pusher material 126 into a double helical pattern 120.

In some embodiments, the inertial fusion target is driven by magnetic pressure generated by absorption of laser energy, absorption of energy from lasers with phase plates, or pulsed-power. For example, driving by magnetic pressure generated by absorption of laser energy may be achieved by pointing the lasers so that they hit the pusher material 126, absorbing the laser energy into thermal energy of the pusher material, conversion of the thermal energy into magnetic energy, then driving the plasma implosion with the magnetic pressure. The magnetic fields may be twisted by shaping the pattern of the laser energy with phase plates 114. For example, driving by magnetic pressure generated by pulsed-power may be achieved by: shaping the pattern of the pusher material 126 into the double helical pattern 120; driving a current, generated by the pulsed-power generator, through the pusher material, which may create a twisted double helical magnetic field and imploded plasma 104.

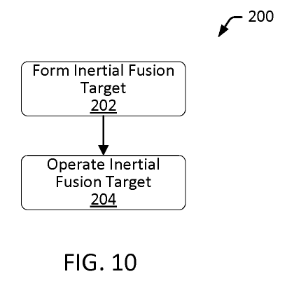

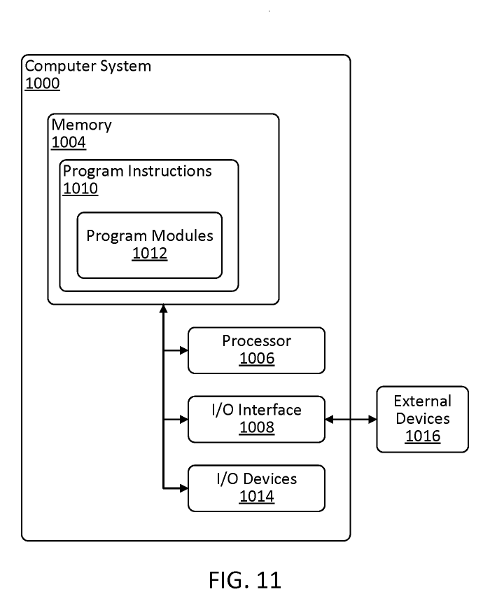

FIG. 10 is a flowchart diagram that illustrates a method of operating an inertial fusion system 200 in accordance with one or more embodiments. In some embodiments, method 200 is conducted by an operator, such as a control system (e.g., a control system that is similar to computer system 1000 described here with regard to FIG. 11).

In some embodiments, method 200 includes forming an inertial fusion target (block 202). This may include: forming an outer structure (e.g., forming an outer layer 126 of a lowatomic number solid material); forming a nuclear fusion fuel structure inside the outer structure (e.g., providing a nuclear fusion fuel layer 124 formed of a solid-density nuclear fusion fuel, such as a layer including DT ice nuclear fusion fuel); and forming an inner volume inside the nuclear fusion fuel structure (e.g., forming an inner fuel volume 122 for receipt of an igniter fuel, such as DT gas or DT wetted foam). In some embodiments, the nuclear fusion fuel structure and the inner volume are formed prior to assembly of the outer structure. In other embodiments, the nuclear fusion fuel structure and the inner volume are formed after the outer structure is formed.

In some embodiments, method 200 includes operating an inertial fusion target (block 204). This may include: providing (e.g., manufacturing, obtaining, positioning, confirming presence, or the like) of an assembled inertial fusion target (e.g., the target 121); determining one or more natural localized spectra of a plasma to be formed from the inertial fusion target, and driving the target in accordance with the natural localized spectra (e.g., determining a pattern that corresponds to natural localized spectra, such as one or more double helical patterns and driving in the pattern), including: applying energy to the inertial fusion target (e.g., driving the initial fusion target by applying laser energy using one or more lasers 116, optionally with phase plates 114, and/or applying electrical energy using a pulsed-power source in a pattern then corresponds to the natural localized spectra for the target); and causing the inertial fusion target to implode such that plasma is formed and evolves toward one or more self-organized structures associated with one or more natural localized spectra (e.g., a double helix 120 or two counter-rotating double helices 118). In some embodiments, implosion of the inertial fusion target results in confinement of the plasma and initiation of nuclear fusion reactions that generate energy. In some embodiments, operating an inertial fusion target may be employed by a control system. For example, an inertial fusion energy generation system may include an inertial fusion target, a control system, including a computer system, such as that described with regard to FIG. 11, where the computer system stores and executes program instructions to implement operation of inertial fusion energy generation, including to provide for the described driving of the inertial fusion target to generate energy. The operation may generate energy that can be harnessed for various uses, such as consumption by an energy driven system or process.

FIG. 11 is a diagram that illustrates an example computer system (or "system") 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as the operations described with regard to FIGS. 1-9.

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here. The 11O interface 1008 may provide an interface for communication with one or more 11O devices 1014, such as a joystick, a computer mouse, a keyboard, or a display screen (e.g., an electronic display for displaying a graphical user interface (GUI)). The 11O devices 1014 may include one or more of the user input devices. The 11O devices 1014 may be connected to the 11O interface 1008 by way of a wired connection (e.g., an Industrial Ethernet connection) or a wireless connection (e.g., a Wi-Fi connection). The 11O interface 1008 may provide an interface for communication with one or more external devices 1016, computer systems, servers or electronic communication networks. In some embodiments, the 11O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word "may" is used in a permissive sense (meaning having the potential to), rather than the mandatory sense (meaning must). The words "include," "including," and "includes" mean including, but not limited to. As used throughout this application, the singular forms "a," "an," and "the" include plural referents unless the content clearly indicates otherwise. Thus, for example, reference to "an element" may include a combination of two or more elements. As used throughout this application, the term "or" is used in an inclusive sense, unless indicated otherwise. That is, a description of an element including A or B may refer to the element including one or both of A and B. As used throughout this application, the phrase "based on" does not limit the associated operation to being solely based on a particular item. Thus, for example, processing "based on" data A may include processing based at least in part on data A and based at least in part on data B, unless the content clearly indicates otherwise. As used throughout this application, the term "from" does not limit the associated operation to being directly from. Thus, for example, receiving an item "from" an entity may include receiving an item directly from the entity or indirectly from the entity (e.g., by way of an intermediary entity). Unless specifically stated otherwise, as apparent from the discussion, it is appreciated that throughout this specification discussions utilizing terms such as "processing," "computing," "calculating," "determining," or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this document, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The techniques described may be further clarified and understood by the following listing of example embodiments:
(a) an inner fuel; and
(b) a cylindrical shell of outer fuel surrounding the inner fuel; and
(c) a cylindrical shell of pusher material surrounding the cylindrical shell of outer fuel, wherein the target is driven using natural localized spectra.

1. A target comprising:

2. The target of embodiment 1, wherein the inner fuel comprises:

(a) low density igniter fuel; or
(b) Deuterium-Tritium (DT) gas; or
(c) Deuterium-Tritium (DT) wetted foam.

3. The target of embodiment 1, wherein the outer fuel comprises:

(a) solid-density nuclear fusion fuel; or
(b) Deuterium-Tritium (DT) ice; or
(c) an efficient, solid at room temperature, fuel; or
(d) Lithium-6-Deuteride (Li6D); or
(e) Hydrogen-Boron-il (HB11).

4. The target of embodiment 1 wherein the pusher material comprises:

(a) low atomic number solid material, or
(b) Beryllium (Be), or
(c) CH plastic. 5. The target of embodiment 1, wherein the drive corresponding to the natural localized

spectra:

(a) is determined by a trained computational model; and/or
(b) is determined by simulation or experimental observation; and/or
(c) comprises a double helical pattern; and/or
(d) comprises two counter-rotating double helical patterns.

6. The target of embodiment 1, wherein the drive is provided by magnetic pressure generated by:

(a) absorption of laser energy; or
(b) absorption of energy from lasers with phase plates; or
(c) pulsed-power,

to provide a desired pattern.

7. The target of embodiment 1, wherein a return current path is provided:

(a) across a top and a bottom of the cylindrical shell; or
(b) from the top to the bottom of the cylindrical shell.

8. The target of embodiment 1, wherein the cylindrical shells are sculpted to drive the target using natural localized spectra.

9. The target of embodiment 1, wherein an artificial intelligence model is used to determine at least one of:

(a) initial conditions;
(b) dimensions of the target;
(c) sculpting of the laser drive; and
(d) sculpting of the target. 10. The target of embodiment 1, further comprising any combination of claims 2 to 9.

11. A target system.

12. The target system of embodiment 11, further comprising the target of any one of embodiments 1-10.

13. A method of operating a target system.

14. The method embodiment 13, the target system comprising the target or target system of any one of embodiments 1-12.

15. A product generated using the target or target system of any one of embodiments 1-12 or

the method of embodiment 13 or embodiment 14.

What is claimed is:

1. A fusion energy generation system, comprising:an inertial fusion target comprising:an inner fuel disposed in an interior region of the target;a cylindrical shell of outer fuel surrounding the inner fuel; anda cylindrical shell of pusher material surrounding the cylindrical shell of outer fuel; anda drive system configured to drive the inertial fusion target in accordance with one or more natural localized spectra of a plasma to be formed from the inertial fusion target.

2. The system of claim 1, wherein the drive system comprises a laser system configured to drive the inertial fusion target.

3. The system of claim 2, wherein the laser system comprises one or more lasers and one or more phase plates configured to produce the one or more natural localized spectra.

4. The system of claim 1, wherein the drive system comprises a pulsed power system configured to drive the inertial fusion target.

5. The system of claim 4, wherein the pulsed power system comprises a pulsed power source configured to drive current through the cylindrical shell of the pusher material, and the cylindrical shell of the pusher material is shaped to produce the one or more natural localized spectra.

6. The system of claim 1, wherein the drive system is configured to drive the cylindrical shell of the pusher material in one or more double helical patterns corresponding to the one or more natural localized spectra.

7. The system of claim 1, wherein the inertial fusion target is configured to be driven by magnetic pressure generated by:absorption of laser energy;
absorption of energy from lasers with phase plates; or pulsed power.

8. The system of claim 1, wherein the inner fuel comprises a nuclear fusion fuel material having a density lower than a density of the outer fuel and that is configured to initiate nuclear fusion reactions within the target.

9. The system of claim 1, wherein the inner fuel comprises a Deuterium-Tritium gas or a Deuterium-Tritium wetted foam.

10. The system of claim 1, wherein the outer fuel comprises a nuclear fusion fuel material in a solid state and having a density greater than a density of the inner fuel.

11. The system of claim 1, wherein the outer fuel comprises Deuterium-Tritium ice, an efficient solid at room temperature fuel, Lithium-6-Deuteride, or Hydrogen-Boron-11.

12. The system of claim 1, wherein the pusher material comprises a solid material having an average atomic number lower than ten.

13. The system of claim 1, wherein the pusher material comprises Beryllium or a Carbon- Hydrogen plastic.

14. The system of claim 1, wherein the one or more natural localized spectra are determined by applying characteristics of the inertial fusion target to a trained computational model that is trained to determine the one or more natural localized spectra based on characteristics of the inertial fusion target.

15. A fusion energy generation method, the method comprising:providing an inertial fusion target comprising:an inner fuel disposed in an interior region of the target;a cylindrical shell of outer fuel surrounding the inner fuel; anda cylindrical shell of pusher material surrounding the cylindrical shell of outer fuel; anddriving the inertial fusion target in accordance with one or more natural localized spectra of a plasma to be formed from the inertial fusion target.

16. The method of claim 15, wherein driving the inertial fusion target comprises driving the inertial fusion target using a laser system.

17. The method of claim 16, wherein the laser system comprises one or more lasers and one or more phase plates that produce the one or more natural localized spectra.

18. The method of claim 15, wherein driving the inertial fusion target comprises driving the inertial fusion target using a pulsed power system.

19. The method of claim 18, wherein the pulsed power system comprises a pulsed power source that drives current through the cylindrical shell of the pusher material, and the cylindrical shell of the pusher material is shaped to produce the one or more natural localized spectra.

20. The method of claim 15, wherein the drive system is configured to drive the cylindrical shell of the pusher material in one or more double helical patterns corresponding to the one or more natural localized spectra.

21. The method of claim 15, comprising obtaining energy generated by way of the driving of the inertial fusion target.

22. An energy generation system, comprising:an inertial fusion target comprising:an inner fuel disposed in an interior region of the target;an outer fuel surrounding the inner fuel; anda pusher material surrounding the outer fuel; anda drive system configured to drive the inertial fusion target in accordance with one or more natural localized spectra of a plasma to be formed from the inertial fusion target.

23. The system of claim 22, wherein the drive system is configured to drive the pusher material in one or more double helical patterns corresponding to the one or more natural localized spectra.

24. A method of energy generation, the method comprising:
driving an inertial fusion target in accordance with one or more natural localized spectra of a plasma to be formed from the inertial fusion target,
the inertial fusion target comprising:an inner fuel disposed in an interior region of the target;an outer fuel surrounding the inner fuel; and a pusher material surrounding the outer fuel.

25. The method of claim 24, wherein driving the inertial fusion target comprises driving the pusher material in one or more double helical patterns corresponding to the one or more natural localized spectra.
